(19) United States
(12) Patent Application Publication
(10) Pub. No.: US 2026/0055963 A1
(43) Pub. Date: Feb. 26, 2026

(54) FURNACE FOR PRODUCING A GRAPHITE PRODUCT

(71) Applicant: NOUVEAU MONDE GRAPHITE INC., Saint-Michel-des-Saints (CA)

(72) Inventors: Patrice BOULANGER, Saint-Michel-des-Saints (CA); Martin BRASSARD, Saint-Michel-des-Saints (CA); René BOISVERT, Saint-Michel-des-Saints (CA); Philippe RIECKMANN, Saint-Michel-des-Saints (CA); Martin SIMARD, Saint-Michel-des-Saints (CA); Elaheh OLIAII, Saint-Michel-des-Saints (CA)

(21) Appl. No.: 19/104,749

(22) PCT Filed: Aug. 29, 2023
(86) PCT No.: PCT/CA2023/051139

§ 371 Date: Feb. 19, 2025

Related U.S. Application Data
(60) Provisional application No. 63/373,896, filed on Aug. 30, 2022.

(51) Int. Cl. F27B 5/02; C01B 32/205; F27B 5/14; F27B 5/16; F27B 14/06; F27D 99/00

(52) U.S. Cl. CPC F27B 5/02; C01B 32/205; F27B 5/14; F27B 5/16; F27B 14/06; F27D 99/0006; F27B 2005/161; F27D 2099/001

(57) ABSTRACT

A furnace for producing a graphite product and associated processes are provided. The furnace can include a furnace housing, an array of crucibles provided within the furnace housing and each having a crucible cavity for receiving a starting material, the crucibles being distributed longitudinally spaced-apart from one another with adjacent ones of the crucibles being distanced from one another to define a gap having a predetermined width therebetween, an electrically conductive packing medium received in the furnace housing to fill each of the gaps and to at least partially surround the crucibles, and first and second electrodes each partially extending into the electrically conductive packing medium. The predetermined width is such that upon passage of an electrical current from the first electrode to the second electrode, resistive heating is generated through both the electrically conductive packing medium and the crucible sidewalls to heat the starting material.

### TECHNICAL FIELD

The technical field generally relates to the production of a graphite product, including a purified graphite product. In particular, the technical field relates to furnaces for producing a graphite product.

### BACKGROUND

There is a growing worldwide demand for graphite, which can be used for instance in the production of lithium-ion batteries. This is at least in part due to the increased use and availability of hand-held electronic devices and the emerging electric vehicle market.

Graphitization or purification furnaces can be used for producing and/or purifying graphite. An example of such furnace is an Acheson furnace, which is configured to produce silicon carbide (SiC) and graphite according to what is known as the “Acheson process”. A typical Acheson furnace includes carbon rods as elements to graphitize that are placed in a resistive bed that includes granular coke and silica, with the longitudinal axes of the carbon rods being placed perpendicular to the direction of the electrical current. As the graphite rods are heated due to the Joule heat generated when the electrical current is passing through the furnace core, a layer of silicon carbide forms around each carbon rod. The silicon carbide can then be further treated as needed to produce graphite. Another example of such furnace is a Length Wise Graphitisation (LWG) furnace. In a typical LWG furnace, the elements to graphitize are placed directly adjacent to each other in a longitudinal array, i.e., without a space therebetween and thus without the presence of a resistive bed therebetween, such that there is a direct electrical connection between adjacent elements. Compared to the Acheson furnace, the LWG can offer advantages such as a shorter heating period, a reduced power consumption and smaller furnace dimensions, for instance.

However, there remain a number of challenges with respect to the production and/or purification of graphite, and particularly with respect to the configuration of furnaces used to produce and/or purify graphite.

### SUMMARY

Some of the implementations of the present description are provided in the following items:
1. A furnace for producing a graphite product, comprising:
a furnace housing comprising a furnace bottom wall and a furnace sidewall extending upwardly from the bottom wall;
an array of crucibles provided within the furnace housing, each of the crucibles having a crucible bottom wall and a crucible sidewall together defining a crucible cavity configured for receiving a starting material therein, the crucibles being distributed longitudinally spaced-apart from one another with adjacent ones of the crucibles being distanced from one another to define a gap having a predetermined width therebetween;
an electrically conductive packing medium received in the furnace housing to fill each of the gaps and to at least partially surround the crucibles; and
first and second electrodes each partially extending into the electrically conductive packing medium, the first and second electrodes being operatively connectable to a power source and being substantially aligned with the array of crucibles and in electrical communication therewith via the electrically conductive packing medium;
   wherein the predetermined width of the gap between the adjacent ones of the crucibles is such that upon passage of an electrical current from the first electrode to the second electrode, resistive heating is generated through both the electrically conductive packing medium and the crucible sidewalls to heat the starting material.
2. The furnace of item 1, wherein the predetermined width ranges from about 0.5 cm to about 30 cm.
3. The furnace of item 1 or 2, wherein the predetermined width ranges from about 5 cm to about 25 cm.
4. The furnace of any one of items 1 to 3, wherein the predetermined width ranges from about 10 cm to about 20 cm.
5. The furnace of any one of items 1 to 4, wherein a ratio between a sidewall thickness of the crucibles and the predetermined width of the gap between the adjacent ones of the crucibles ranges from about 0.083 to about 20.
6. The furnace of any one of items 1 to 5, wherein the electrically conductive packing medium comprises calcinated petroleum coke.
7. The furnace of item 6, wherein the calcinated petroleum coke comprises particles having a size below 0.5 mm, between about 0.2 mm and about 2 mm, between about 5 mm and about 10 mm, or between about 10 mm and about 20 mm.
8. The furnace of any one of items 1 to 7, wherein the electrically conductive packing medium has a bulk density ranging from about 500 kg/m³ to about 1200 kg/m³.
9. The furnace of any one of items 1 to 8, wherein the electrically conductive packing medium entirely surrounds the crucibles.
10. The furnace of any one of items 1 to 9, wherein the crucibles are rectangularly shaped.
11. The furnace of any one of items 1 to 10, further comprising a gas inlet to introduce a gas in a corresponding one of the crucible cavities.
12. The furnace of item 11, wherein the gas inlet comprises an injection lance to inject the gas in the corresponding one of the crucible cavities.
13. The furnace of item 11 or 12, wherein the gas comprises an inert gas and/or a reactive gas.
14. The furnace of any one of items 11 to 13, wherein the gas comprises chlorine, CFC, HFC, carbon monoxide, air, and/or oxygen.
15. The furnace of any one of items 1 to 14, further comprising a dividing wall extending across a section of the crucible cavity to facilitate diffusion of heat.
16. The furnace of item 15, wherein the dividing wall passes through a center region of the crucible cavity.
17. The furnace of item 15 or 16, wherein the dividing wall extends substantially parallel to the first and second electrodes.
18. The furnace of item 15 or 16, wherein the dividing wall extends substantially perpendicular to the first and second electrodes.
19. The furnace of item 15 or 16, wherein the dividing wall comprises first and second dividing walls, the first dividing wall extending substantially parallel to the first and second electrodes and the second dividing wall extending substantially perpendicular to the first and second electrodes.
20. The furnace of item 15 or 16, wherein the dividing wall comprises first and second dividing walls, the first and second dividing walls crossing each other to form a cross.
21. The furnace of item 15 or 16, wherein the dividing wall is provided at a height that is substantially aligned with at least one of the first and second electrodes.
22. The furnace of item 15 or 16, wherein the dividing wall extends upwardly from the crucible bottom up to a height of at least one of the first and second electrodes.
23. The furnace of item 15 or 16, wherein the dividing wall extends upwardly from the crucible bottom up to a top region of the crucible cavity.
24. The furnace of any one of items 1 to 23, wherein the starting material is selected from the group consisting of natural graphite, artificial graphite, exfoliated graphite, graphene materials, coke, and mixtures thereof.
25. The furnace of item 24, wherein the starting material comprises recycled graphite.
26. The furnace of item 24, wherein the coke comprises needle coke.
27. The furnace of any one of items 1 to 25, wherein the starting material is a spheronized graphite material, and the graphite product is a spheronized and purified graphite product.
28. The furnace of any one of items 1 to 25, wherein the starting material is a prismatic graphite material, and the purified graphite material is a prismatic and purified graphite material.
29. The furnace of any one of items 1 to 28, wherein the furnace housing comprises first and second furnace housings within which is received a corresponding array of the crucibles, the first and second electrodes being in electrical communication with the corresponding arrays of the crucibles via a shunt.
30. The furnace of item 29, wherein the first and second electrodes are provided on a same side of the first and second furnace housings.
31. The furnace of any one of items 1 to 28, wherein the first and second electrodes are provided on opposite sides of the furnace housing.
32. The furnace of any one of items 1 to 31, wherein the graphitization furnace further comprises a hood to recover off-gases generated during production of the graphite product.
33. The furnace of any one of items 1 to 32, wherein the first electrode is in direct contact with a first outermost crucible on a first side of the array of crucibles, and the second electrode is in direct contact with a second outermost crucible on a second side of the array of crucibles.
34. The furnace of any one of items 1 to 32, wherein the first and second electrodes each partially extends into the electrically conductive packing medium without directly contacting the crucibles.
35. A process for producing a graphite product, comprising:
placing a starting material into crucible cavities of corresponding crucibles forming part of an array of crucibles provided within a furnace housing of a furnace, the crucibles being distributed longitudinally spaced-apart from one another with adjacent ones of the crucibles being distanced from one another to define a gap having a predetermined width therebetween;
generating an electrical current between a first electrode and a second electrode of the furnace, the first and second electrodes being in electrical communication with an electrically conductive packing medium received within the furnace housing of the furnace to fill each of the gaps and to at least partially surround the crucibles;
maintaining the electrical current between the first electrode and the second electrode to reach a reaction temperature within the housing furnace and for a reaction time sufficient to produce the graphite product;
wherein the predetermined width of the gap between the adjacent ones of the crucibles is such that upon passage of an electrical current from the first electrode to the second electrode, resistive heating is generated through both the electrically conductive packing medium and the crucible sidewalls to heat the starting material.
36. The process of item 35, wherein the reaction temperature ranges from about 300° C. to 3200° C.
37. The process of item 35 or 36, wherein the reaction time ranges from about 4 hours and about 24 hours.
38. The process of any one of items 35 to 37, further comprising recovering off-gases generated during the production of the graphite product.
39. The process of any one of items 35 to 38, wherein the graphite product is a purified graphite product.
40. The process of item 39, further comprising:
subjecting the starting material to oxidizing conditions, in presence of oxygen, to convert metal sulfide impurities into metal oxides and sulfur dioxide, thereby obtaining a metal sulfide-lean graphite material;
subjecting the metal sulfide-lean graphite material to carbochlorination, in presence of chlorine gas, to convert the metal oxides into metal chlorides and obtain a metal chloride-rich graphite material; and
purging the metal chlorides from the metal chloride-rich graphite material, thereby obtaining a purified graphite material.
41. The process of item 40, wherein subjecting the starting material to oxidizing conditions comprises:
a first oxidation step performed at a first temperature that is lower than a decomposition temperature of the metal sulfide impurities, to convert the metal sulfide impurities into metal sulfates and obtain a pre-treated graphite material; and
a second oxidation step performed on the pre-treated graphite material at a second temperature that is higher than the first temperature, to convert the metal sulfates into metal oxides and sulfur dioxide and obtain the metal sulfide-lean graphite material.
42. The process of item 41, wherein the first oxidation step is performed in a first reactor; and the second oxidation step, the subjecting the metal sulfide-lean graphite material to carbochlorination and the purging the metal chlorides are performed in the furnace.
43. The process of item 42, wherein the first reactor is selected from the group consisting of kiln, a fluidized bed reactor, a fixed bed reactor and a rotating bed reactor.
44. The process of any one of items 40 to 43, further comprising purging the sulfur dioxide from the metal sulfide-lean graphite material prior to subjecting the metal sulfide-lean graphite material to carbochlorination.
45. The process of item 44, wherein purging the sulfur dioxide from the metal sulfide-lean graphite material comprises purging the sulfur dioxide with a first inert gas.
46. The process of any one of items 40 to 45, wherein purging the metal chlorides from the metal chloride-rich graphite material comprises:
purging with a second inert gas;
maintaining the metal chloride-rich graphite material at a temperature at which the metal chlorides are in a gaseous state; and
recovering outlet gas comprising the metal chlorides.

### BRIEF DESCRIPTION OF THE DRAWINGS

The attached figures illustrate various features, aspects and implementations of the technology described herein.

FIG. 1 is a top view of a furnace in accordance with an implementation, the furnace including a furnace housing, an array of longitudinally spaced-apart crucibles received in the furnace housing, and first and second electrodes.

FIG. 2 is a side view of the furnace of FIG. 1.

FIG. 3 is a top view of a furnace in accordance with another implementation, the furnace including first and second furnace housings, an array of longitudinally spaced-apart crucible received in each of the first and second furnace housings, first and second electrodes, and a shunt.

FIG. 4 is a longitudinal side view of the furnace of FIG. 3.

FIG. 5 is a lateral side view of the furnace of FIG. 3.

FIGS. 6A to 6F are top views of a crucible that includes one or more dividing walls.

FIGS. 7A to 7C are side views of a crucible that includes a dividing wall.

### DETAILED DESCRIPTION

Techniques described herein relate to a furnace and associated method for producing a graphite product.

In general terms, the furnace includes a furnace housing comprising a furnace bottom wall and a furnace sidewall extending upwardly from the furnace bottom wall. An array of crucibles is provided within the furnace housing. Each of the crucibles includes a crucible bottom wall and a crucible sidewall together defining a crucible cavity configured for receiving a starting material therein, i.e., a material the once having been subjected to heating will produce the graphite product. The crucibles are distributed longitudinally spaced-apart from one another to form the array of crucibles. Given that the crucibles are longitudinally spaced-apart from one another, there is a gap between adjacent ones of the crucibles. This gap can have a predetermined width, which can be chosen according to various factors. An electrically conductive packing medium is received in the furnace housing to fill each of the gaps between the crucibles and to at least partially surround the crucibles. The furnace further comprises first and second electrodes that each partially extends into the electrically conductive packing medium, and that may or may not directly contact the crucibles, i.e., the first electrode may or may not contact the outermost crucible of the array located at the first side of the furnace housing, and the second electrode may or may not contact the outermost crucible of the array located at the second side of the furnace housing. In other words, the electrodes are in contact with the electrically conductive packing medium, and may or may not be in direct contact with the crucibles. The first and second electrodes are operatively connectable to a power source, and are substantially aligned with the array of crucibles and in electrical communication therewith via the electrically conductive packing medium.

The predetermined width of the gap between the adjacent ones of the crucibles can be chosen such that upon passage of an electrical current from the first electrode to the second electrode, resistive heating is generated through both the electrically conductive packing medium and the crucible walls to heat the starting material. This configuration of the furnace can thus enable to take advantage of the resistive heating generated from both the electrically conductive packing medium and the wall of the crucibles, thereby increasing the heating output to enhance the production of the graphite product. This is in contrast with furnaces known in the art, which are configured either to generate resistive heating within the packing medium or to generate heating through the walls of crucibles.

In accordance with the implementations described herein, it was found that modifying the distance between longitudinally adjacent crucibles so as to arrive at one that enables generating resistive heating in both the electrically conductive packing medium and the walls of the crucible can contribute to enhance the performance of the furnace.

Various implementations and features of the furnace will now be described in greater detail in the following paragraphs.

### General Description of the Furnace

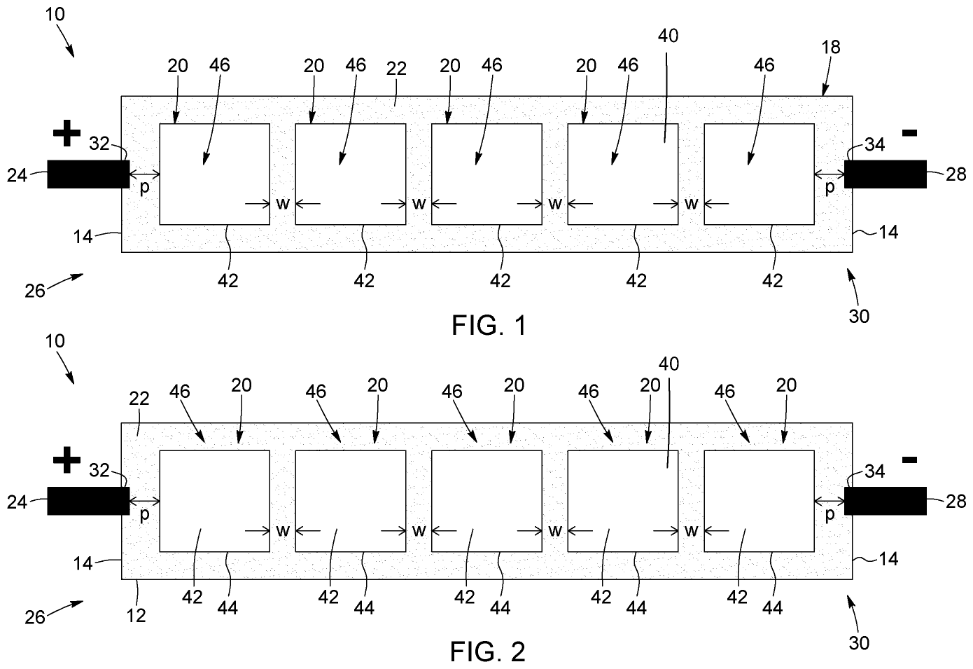

With reference to FIGS. 1 to 5, a furnace 10 is shown. It is to be noted that as used herein, the term “furnace” refers to a furnace which can be used for graphitization and/or for purification of graphite. It is understood that the term “furnace” should not be interpreted as being limited to a furnace used for graphitizing a starting material, i.e., to produce graphite as the graphite product from a non-graphite product. For instance, the furnace as described herein can be used to perform purification of a starting graphite material to produce a graphite product that is purified compared to the starting graphite material, e.g., purified graphite, or to perform graphitization of a starting material to produce a graphite product e.g., graphite. Other uses of the furnace are also within the scope of the present description.

Referring more particularly to FIGS. 1 and 2, in the illustrated implementation, the furnace 10 includes a bottom wall 12, sidewalls 14. It is to be noted that in other implementations, a top wall can be present. The combination of the bottom wall 12 and sidewalls 14 define a furnace housing 18.

The furnace housing 18 is configured for receiving an array of crucibles 20 therein. In the implementation shown, each crucible is rectangularly shaped, and includes a crucible bottom wall 44, a crucible sidewall 42, and a crucible lid 40. It is to be noted that in the context of the present description, the crucible bottom wall 44 and the crucible sidewall 42, and the crucible lid 40 if present, can collectively be referred to as the wall or walls of the crucible. The combination of the crucible bottom wall 44 and the crucible sidewall 42 together define a crucible cavity 46. The crucible 20 can be made of various materials as known in the art, and for instance can be made of a material that includes graphite, amorphous carbon, silicon carbide, clay, etc. It is to be noted that although the illustrated implementation of the crucible 20 shows the crucibles 20 as having a rectangular shape, in other implementations, the crucibles 20 can have a different shape than a rectangular shape. For instance, the crucible 20 can be cylindrical, or have any other suitable shape as known in the art. In addition, the crucible sidewall can be tapered, or be straight. In some implementations, crucibles having a rectangular shape can provide certain benefits, such as increasing the space taken by the crucibles within the furnace housing, for instance compared to cylindrical crucibles, thereby increasing the volume of starting material that can treated during a given graphitization or purification process. For instance, in some implementations, providing rectangularly shaped crucibles can enable increasing the surface occupied by the crucibles, i.e., the longitudinal surface area defined by the crucible, to more than about 75%, more than about 80%, more than about 85%, or more than about 95%. In some implementations, providing rectangular crucibles can enable conducting the electrical current in a preference path, thereby enhancing the concentration of heat in the packing medium between adjacent crucibles.

The crucible cavity 46 is configured to receive therein a starting material that will be subjected to graphitization or purification. The nature of the starting material can vary depending on the intended use of the furnace. For instance, when the furnace is intended to be used as a purification furnace, the starting material can include particulate graphite at various processing stages, to be purified. The particulate graphite to be purified is typically of a lower purity (e.g., less than about 99.95% graphite), and can include for instance artificial or natural graphite and can also include recycled graphite. Non-limiting examples of a starting material to be purified can include graphite flakes, micronized graphite, spheronized graphite and prismatic graphite. In some implementations, the starting material to be purified can be selected from the group consisting of natural graphite, artificial graphite, exfoliated graphite, graphene materials and mixtures thereof. The starting material to be purified may be of all sizes. For example, the size of the graphite particles can be from less than 5 μm to more than 1000 μm in diameter or from about 50 μm to about 800 μm in diameter. For example, the graphite particles can have a thickness between about 1 μm and about 150 μm. In other implementations, when the furnace is used to produce a graphite product via graphitization, the starting material can include graphene, coke (e.g., needle coke) and mixtures thereof, among others.

In the implementation shown, a total of five crucibles 20 are illustrated. In other implementations, at least two crucibles 20 can be provided in the furnace housing 18. It is to be understood that any other number of crucibles can also be suitable as long as there is a plurality of crucibles, the number of crucibles shown in FIG. 1 being for illustrative purposes only.

The crucibles 20 are provided longitudinally spaced-apart from one another. When referring to the term “longitudinally” in the context of the present description, it is intended to mean that the crucibles 20 are aligned along a length of the furnace housing 18. Providing the crucibles 20 in an array, and longitudinally spaced-apart from one another, can thus be interpreted as the crucibles being side-by-side relative to one another to form the array along the length of the furnace housing 18. Given that the crucibles 20 are longitudinally spaced-apart from one another, there is a distance between adjacent ones of the crucibles 20, i.e., between the sidewalls 42 of adjacent crucibles 20. This distance corresponds to a predetermined width W of a gap that is present between adjacent ones of the crucibles 20, as show in FIGS. 1 and 2. This aspect will be described in further detail below.

A packing medium 22 is provided within the furnace housing 18. In the implementation shown in FIGS. 1 and 2, the packing medium 22 fills the furnace housing 18 substantially entirely, such that there is packing medium 22 surrounding the crucibles 20, including on top of the crucibles 20, so as to surround the crucibles 20 on all sides. In the implementation shown, given that there is no top wall present, the top surface of the packing medium 22 is exposed to air. In some implementations, a hood can be placed over the top of the furnace 10, for instance to recover fumes. The packing medium 22 is an electrically conductive packing medium that enables passage of an electrical current therethrough.

Various types of packing mediums can be suitable. For instance, in some implementations, the packing medium can include calcinated petroleum coke. Using calcinated petroleum coke can provide various benefits, for instance given its lower content in ashes compared to other types of coke such as metallurgical coke. In some implementations, the calcinated petroleum coke can include particles having a size below 0.5 mm, or a size ranging between about 0.2 mm and about 2 mm, between about 5 mm and about 10 mm, and/or between about 10 mm and 20 mm. It is to be noted that although calcinated petroleum coke is provided as an example of packing medium, any other type of packing medium having given properties, for instance in terms of thermal conductivity and electrical conductivity, can also be suitable.

Other examples packing medium 22 includes one or more of metallurgical coke, charcoal, or biochar. The packing medium can have various characteristics that can be varied according to specific needs. For instance, the thermal conductivity at room temperature of the packing medium 22 can range from between about 0.2 W/m·K to about 0.4 W/m·K. The bulk density of the packing medium 22 can range from about 500 kg/m³ to about 1200 kg/m³.

The furnace 10 further comprises a first electrode 24 provided on a first side 26 of the furnace housing 18, and a second electrode 28 provided on a second side 30 of the furnace housing 18. In the implementation shown in FIG. 1, the first electrode 24 is a positive electrode and the second electrode 28 is a negative electrode. It is to be understood that this configuration can be reversed, and the first electrode 24 can be negative electrode and the second electrode 28 can be a positive electrode.

The first electrode 24 includes a first electrode end portion 32 and the second electrode 28 includes a second electrode end portion 34. Each of the first electrode end portion 32 and the second electrode end portion 34 extends within the furnace housing 18 so as to be in contact the packing medium 22. In the implementation shown, the first electrode end portion 32 and the second electrode end portion 34 are shown as not directly contacting a corresponding one of the outermost crucibles 20 of the array of crucibles. As mentioned above, it is to be noted that in other implementations, the first electrode end portion 32 and the second electrode end portion 34 can be in direct contact with a corresponding one of the outermost crucibles 20 of the array of crucibles. Thus, with reference to the implementation shown in FIGS. 1 and 2, the first and second electrodes 24, 28 extend within the furnace housing 18 on their respective sides 26, 30 of the furnace housing 18, according to a penetration distance P that is sufficient for the first electrode end portion 32 and the second electrode end portion 34 be in contact with the packing medium 22 to resistively heat the packing medium 18 upon passage of an electrical current from the first electrode 24 to the second electrode 28. Furthermore, the penetration distance P of the first and second electrodes 24, 28 can be chosen such that the first electrode end portion 32 and the second electrode end portion 34 are spaced-apart from the crucibles 20 that are directly adjacent therewith, as shown in FIGS. 1 and 2. In other implementations, the penetration distance P can be such that the first electrode end portion 32 and the second electrode end portion 34 are in contact with the wall of the crucibles 20 that are directly adjacent therewith.

In some implementations, the array of crucibles 20 is substantially aligned with the first electrode 24 provided on the first side 26 of the furnace housing 18 and the second electrode 28 provided on the second side 30 of the furnace housing 18, the second side 30 being opposite to the first side 26. When referring to the array of crucibles 20 that is substantially aligned with the first and second electrodes 24, 28, it is intended to mean that the array of crucibles 20 passes through a straight line that extends between the first and second electrodes 24, 28. In some implementations, a center region of the crucibles 20 can pass through the straight line extending between the first and second electrodes 24, 28. In other implementations, the crucibles 20 can be arranged in the furnace housing 18 such that the straight line that extends between the first and second electrodes 24, 28 is above or below the respective central regions of the crucibles 20, or on either side of the respective central regions of the crucibles 20. Although the crucibles 20 shown in FIGS. 1 and 2 are provided such that each crucible 20 is at the same distance from the furnace sidewalls 14 and from the furnace bottom wall 12, it is to be understood that there can be a variation in the location of the crucibles 20, with some of the crucibles being located closer to the furnace sidewalls 14 than others, and/or with some of the crucibles being located closer to the furnace bottom wall 12 than others.

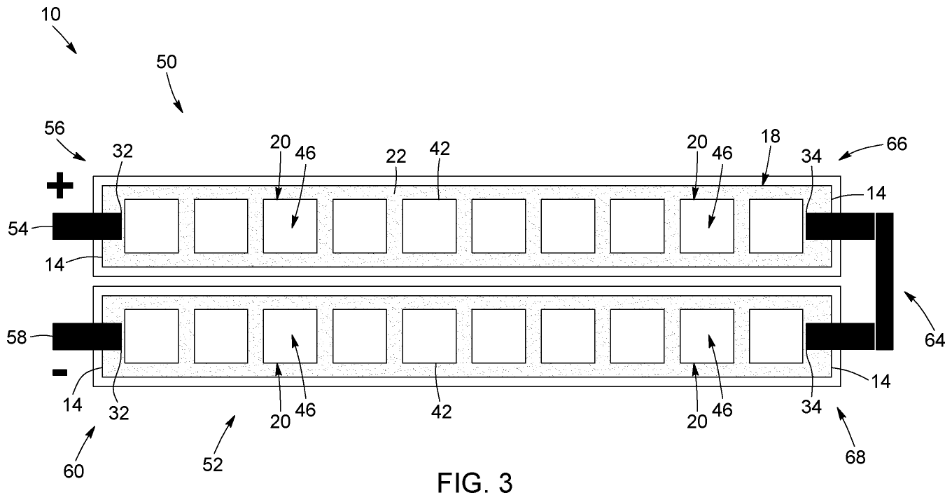

Referring now to FIGS. 3 to 5, another implementation of the furnace 10 is shown. In this implementation, the furnace 10 includes a first furnace housing 50 and a second furnace housing 52. Each of the first and second furnace housings 50, 52 includes a corresponding array of crucibles 20 and a packing medium 22 received therein, as described in connection with FIGS. 1 and 2. Although the furnace 10 of FIGS. 3 to 5 includes two furnace housing 50, 52, it is to be understood that in other implementations, the furnace 10 can include more than two furnace housings as needed.

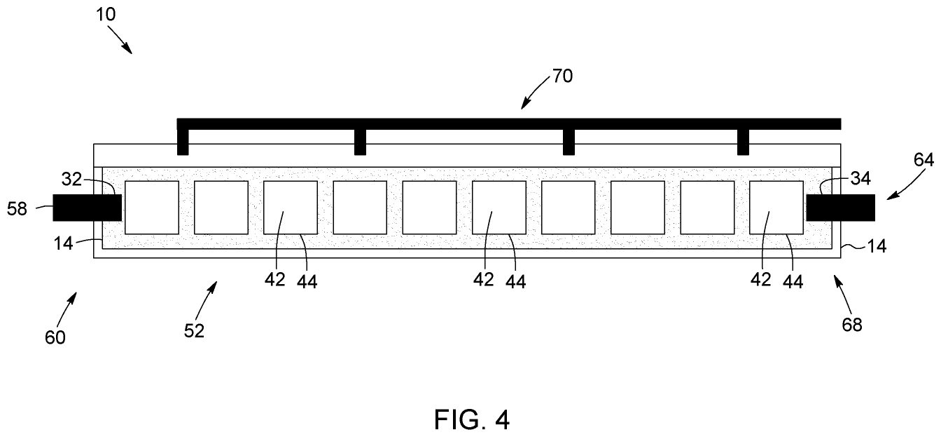

In the implementation shown in FIGS. 3 and 4, a first electrode 54 is provided on a first side 56 of the first furnace housing 50, and a second electrode 58 is provided on a first side 60 of the second furnace housing 52, the first side 56 of the first furnace housing 50 and the first side 60 of the second furnace housing 52 being on the same side of the furnace 10. The furnace 10 further comprises a shunt 64 provided on the opposite side thereof, i.e., on the second side 66 of the first furnace housing 50 and on the second side 68 of the second furnace housing 52. The shunt 64 is configured to enable passage of an electrical current from the first electrode 54 to the second electrode 58. In some implementations, the first furnace housing 50 and the second furnace housing 52 can be spaced-apart from each other, as shown in FIGS. 3 to 5. In some implementations, the space between the first furnace housing 50 and the second furnace housing 52 can be exposed to air. Alternatively, the space between the first furnace housing 50 and the second furnace housing 52 can be substantially sealed.

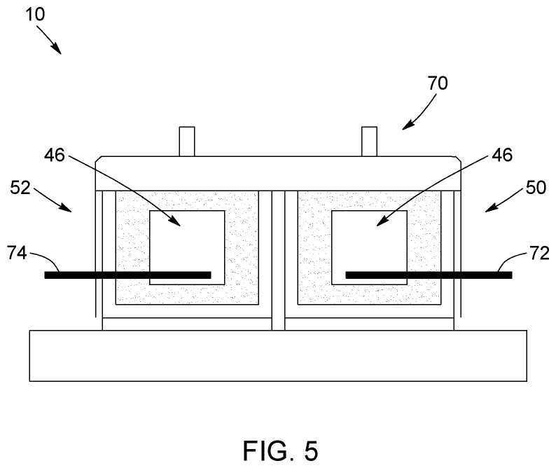

Referring more particularly to FIGS. 4 and 5, the furnace 10 further includes a hood 70 to recover off-gases that can be generated during the graphitization or purification process. The off-gases can be further treated as needed, for example to meet environmental standards. In some implementations, the hood 70 can be considered as corresponding to a top wall of the furnace housing 18.

In some implementations, and for instance when the furnace is used to produce a graphite product that is purified from a starting material that includes graphite particles, the furnace 10 can further include a gas inlet to introduce a gas into a corresponding one of the crucible cavities 46. Referring to FIG. 5, the gas inlet is shown as including an injection lance 72, 74 that extends within the crucible cavity 46 of a corresponding one of the crucibles 20. Given that FIG. 5 is a side view of the first and second furnace housing 50, 52, the injection lance 72 is shown as extending within the crucible cavity 46 of the outermost crucible of the array of crucibles 20 received in the first furnace housing 50, while the injection lance 74 is shown extending within the crucible cavity 46 of the outermost crucible of the array of crucibles 20 received in the second furnace housing 52. It is to be understood that an injection lance 72, 74 can be provided for each corresponding crucible of the array of crucibles 20. In alternative implementations, selected crucibles of the array of crucibles 20 can be paired with a corresponding injection lance. The injection lance 72 is configured to introduce a gas into a corresponding crucible cavity 46. In alternative implementations, injection lances 72, 74 can be positioned outside of the crucible cavity 46 so as to extend in the packing medium 22. The gas can include for instance an inert gas or a reactive gas. In some implementations, the gas can include chlorine, CFC, HFC, carbon monoxide, air, oxygen, etc. More details regarding selected gas that can be introduced in the crucible cavities in a given step of the purification process are provided below.

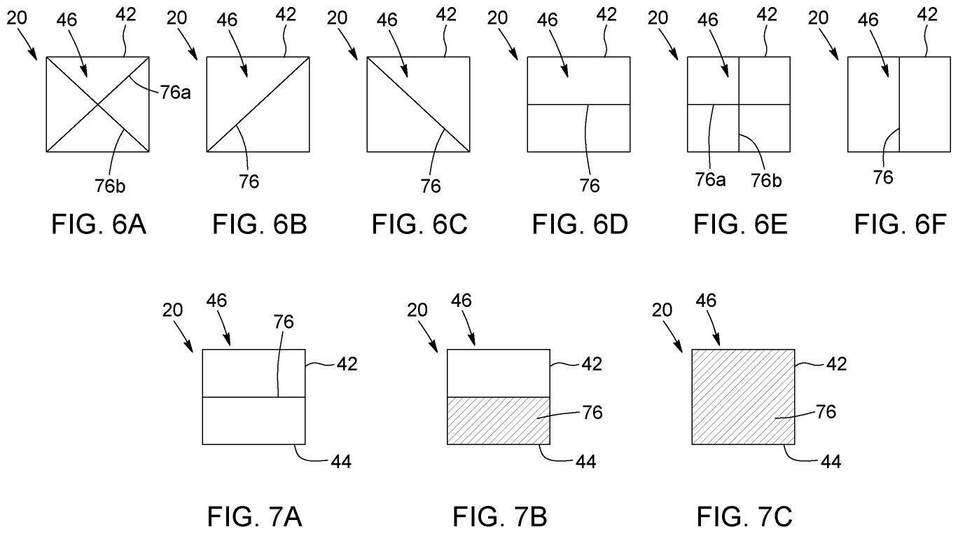

Referring to FIGS. 6A to 6F, each illustrating a top view of a corresponding crucible 20, one or more dividing wall 76 can be provided within the crucible cavity 46 of the corresponding crucible 20. The dividing wall 76 is configured to facilitate diffusion of the resistive heat generated by the passage of an electrical current from the first electrode to the second electrode.

In FIG. 6A, a first dividing wall 76a and a second dividing wall 76b extend within the crucible cavity 46 of a corresponding crucible 20. More particularly, the first dividing wall 76a extends from a first corner of the crucible cavity 46 to a third corner of the crucible cavity 46, and the second dividing wall 76b extends from a second corner of the crucible cavity 46 to a fourth corner of the crucible cavity 46, thereby forming a cross.

In FIG. 6B, the dividing wall 76 extends from a second corner of the crucible cavity 46 to a fourth corner of the crucible cavity 46. In FIG. 6C, the dividing wall 76 extends from a first corner of the crucible cavity 46 to a third corner of the crucible cavity 46.

In FIG. 6D, the dividing wall 76 extends substantially parallel to a first electrode 24 that would be provided on the first side 26 of the furnace housing 18 and/or to a second electrode 28 that would be provided on the second side 30 of the furnace housing 18.

In FIG. 6E, a first dividing wall 76a and a second dividing wall 76b extend within the crucible cavity 46 of a corresponding crucible 20. More particularly, the first dividing wall 76a extends substantially parallel to a first electrode 24 that would be provided on the first side 26 of the furnace housing 18 and/or to a second electrode 28 that would be provided on the second side 30 of the furnace housing 18, and the second dividing wall 76b extends substantially perpendicularly to a first electrode 24 that would be provided on the first side 26 of the furnace housing 18 and/or to a second electrode 28 that would be provided on the second side 30 of the furnace housing 18, thereby forming a “plus” sign.

In FIG. 6F, the dividing wall 76 extends substantially perpendicularly to a first electrode 24 that would be provided on the first side 26 of the furnace housing 18 and/or to a second electrode 28 that would be provided on the second side 30 of the furnace housing 18.

FIGS. 7A to 7C each illustrates a side view of a corresponding crucible 20, when a single dividing wall 76 is provided in the crucible cavity 46 of the corresponding crucible 20. The dividing wall 76 can extend at various heights along the depth of the crucible 20. In FIG. 7A, the dividing wall 76 extends across the crucible cavity 46 at a height that is within a central region of the crucible cavity 46. In FIG. 7B, the dividing wall 76 extends upwardly from the bottom wall 44 of the crucible 20, up to a central region of the crucible cavity 46. In FIG. 7C, the dividing wall 76 the dividing wall 76 extends upwardly from the bottom wall 44 of the crucible 20 up to a top region of the crucible cavity 46. FIGS. 7B and 7C can be interpreted as corresponding to side views of FIG. 6D, with the difference that in FIG. 7B, the dividing wall 76 extends up to the central region of the crucible cavity 46 while in FIG. 7C, the dividing wall 76 the dividing wall 76 extends upwardly from the bottom wall 44 of the crucible 20 up to the top region of the crucible cavity 46.

It is to be understood that the various configurations of the one or more dividing walls show in FIGS. 6A to 6F and 7A to 7C are for illustrative purposes only, and that other configurations are also possible.

Width W of the gap formed between adjacent crucibles of the furnace

Additional details regarding the configuration of the array of crucibles 20 received in the furnace housing of the furnace will now be provided.

As mentioned above, the crucibles 20 are provided longitudinally spaced-apart from one another, such that there is a gap having a predetermined width W between adjacent ones of the crucibles 20, i.e., between the sidewalls 42 of adjacent crucibles 20.

The predetermined width W of the gaps can be chosen according to various factors. Examples of such factors are described below.

As a general consideration, the predetermined width W can be chosen such that upon passage of an electrical current from the first electrode to the second electrode of the furnace, resistive heating is generated through both the electrically conductive packing medium and the crucible sidewalls to enhance the heat provided to the starting material placed in the crucible cavity.

The predetermined width W can thus be chosen so as to be sufficiently small to enable resistive heating to occur through both the electrically conductive packing medium and the walls of the crucibles. On the other hand, the predetermined width W can also be chosen so as to be sufficiently large such that a given volume of the electrically conductive packing medium can be inserted between the adjacent crucibles. Having a sufficient volume of the electrically conductive packing medium inserted between the adjacent crucibles can facilitate the passage of the electrical current from the electrically conductive packing medium to the walls of the crucibles, such that resistive heating also occurs in the walls of the crucibles. In addition, the given volume of the electrically conductive packing medium can be chosen according to the quantity, or volume, of the starting material that is to be received in the crucible cavities of the crucibles. For instance, for a larger volume of starting material, a larger volume of electrically conductive packing medium may be desired to enable the resistive heating generated by the passage of an electrical current in the electrically conductive packing medium and the resistive heating through the walls of the crucibles to effectively heat the starting material. Alternatively, for a smaller volume of starting material, a smaller volume of electrically conductive packing medium may be desired to enable the resistive heating generated by the passage of an electrical current in the electrically conductive packing medium and the resistive heating thought the walls of the crucibles to effectively heat the starting material.

On the other hand, for a larger volume of starting material, it can be desirable to provide crucibles 20 having a larger crucible cavity 46, for instance by increasing the length of the crucibles 20 and thus respective crucible cavities. When using larger sized crucibles 20, the predetermined width W can be reduced to accommodate a given number of crucibles 20 in the furnace housing 18. In the same order of ideas, crucibles 20 having a given crucible cavity 46 and already being provided in the furnace housing 18 can determine the volume of starting material that can be received in the crucible cavities 46, and the resulting predetermined width W between adjacent crucibles 20 for this size of crucibles thus corresponds to the remaining gap between adjacent crucibles 20 when this size of crucibles is used.

The predetermined width W can also vary according to the thickness of the walls, e.g., the sidewalls, of the crucibles. For instance, for crucibles having walls that are considered thick, the predetermined width W can be chosen to be wider, such that more resistive heating can be generated through the electrically conductive packing medium and reach the entire thickness of the walls of the crucibles. On the other hand, for crucibles having walls that are considered thin, the predetermined width W can be chosen to be thinner as well, as a smaller volume of the electrically conductive packing medium in the gap between adjacent crucibles may be needed to heat the walls of the crucibles via the resistive heating generated through the electrically conductive packing medium. In such implementations, the predetermined width W can thus be considered to be adjustable proportionally to the thickness of the walls of the crucibles. In some implementations, the wall thickness of the crucibles can vary between about 2.5 cm and about 10 cm, although other wall thicknesses may also be suitable.

In some implementations, the predetermined width W can be chosen so as to be within a given range of a ratio between a sidewall thickness of the crucibles and the predetermined width W of the corresponding gap between adjacent ones of the crucibles. For instance, it can be determined that enhanced performance of the furnace can be achieved when the thickness of the sidewalls of the crucibles is between about 2.5 cm and about 10 cm, and with the width of the gap between adjacent crucibles being between about 0.5 cm and about 30 cm, the ratio between a sidewall thickness of the crucibles and the predetermined width W of the gap between adjacent crucibles can thus be between about 0.083 and about 20. It is to be noted that other ratios may also be suitable depending on the wall thickness of the crucibles and the predetermined width W of the gap between adjacent crucibles.

In some implementations, the predetermined width W can range between about 0.5 cm and about 30 cm, between about 5 cm and about 25 cm, or between about 10 cm and about 20 cm.

In some implementations, the predetermined width W between adjacent crucibles can be the same along the entire length of the array of crucibles, as shown in FIGS. 1 to 5. It is to be understood that in other implementations, the predetermined width W can vary between selected pair of adjacent crucibles, to achieve a given pattern. For instance, in some implementations, the predetermined width W can be chosen to be smaller for crucibles that are located in closer proximity to the first and second electrodes compared to the predetermined width W for crucibles that are located in a central portion of the array of crucibles. In other implementations, the predetermined width W between a first pair of adjacent crucibles, closest to the first electrode, can be within a first range, the predetermined width W between a second pair of adjacent crucibles, next to the first pair of adjacent crucibles, can be within a second range that is different from the first range, the predetermined width W between a third pair of adjacent crucibles, next to the second pair of adjacent crucibles, can be within a third range that is different or the same as the first range, and that is different from the second range, etc. In some implementations, varying the predetermined width W between pairs of adjacent crucibles along the length of the furnace housing can contribute to enhancing the resistive heating generated through both the electrically conductive packing medium and the crucible walls.

### Process Implementations

A process for producing a graphite product using the furnace will now be described in further detail.

In some implementations, the process for producing a graphite product can include the purification of a starting material that includes graphite, with the graphite product that is produced corresponding to a purified graphite product. In such implementations and as mentioned above, the furnace can thus be referred to as a purification furnace. Examples of such purification processes can be found in PCT application No. PCT/CA2022051223, which is incorporated herein by reference in its entirety.

The process for producing a graphite product, i.e., a purified graphite product, can include subjecting the starting material to oxidizing conditions in the presence of oxygen, to convert metal sulfide impurities that may be present in the starting material into metal oxides and sulfur dioxide, thereby obtaining a metal sulfide-lean graphite material. As mentioned above, the starting material can include for instance natural graphite, artificial graphite, recycled graphite, exfoliated graphite, graphene, graphene materials, coke (such as needle coke), etc. The starting material can take the form of graphite flakes, micronized graphite, spheronized graphite, and prismatic graphite, for example.

In some implementations, subjecting the starting material to oxidizing conditions can include placing the starting material into the crucible cavities of corresponding crucibles that form part of an array of crucibles provided within a furnace housing of the furnace described herein. The crucibles are distributed longitudinally spaced-apart from one another with adjacent ones of the crucibles being distanced from one another to define a gap having a predetermined width W therebetween. An oxygen-containing gas can be introduced into the furnace housing to provide the oxidizing conditions. Alternatively, the oxidation step can be effected with the oxygen present in the oxygen directly surrounding the starting material that is to be purified.

In other implementations, subjecting the starting material to oxidizing conditions can include a first oxidation step performed at a first temperature that is lower than a decomposition temperature of the metal sulfide impurities, to convert the metal sulfide impurities into metal sulfates and obtain a pre-treated graphite material; and a second oxidation step performed on the pre-treated graphite material at a second temperature that is higher than the first temperature, to convert the metal sulfates into metal oxides and sulfur dioxide and obtain the metal sulfide-lean graphite material.

When the process includes the first and second oxidation steps described above, the starting material can be introduced into a first reactor, provided upstream of the furnace, where the first oxidation step is carried out in the presence of oxygen. Thus, instead of the starting material being placed into the crucibles of the furnace as described above, the starting material is initially introduced into the first reactor. The first reactor can include for instance a kiln, a fluidized bed reactor, a fixed bed reactor or a rotating bed reactor.

In some implementations, when the first and second oxidation steps are performed, the first oxidation step that is carried out in the first reactor can be a partial oxidation step, to convert the metal sulfide impurities into metal sulfates and produce a pre-treated graphite material. In other implementations, the first oxidation step that is carried out in the first reactor can be a complete oxidation step, to convert the metal sulfide impurities into metal oxides and sulfur dioxide. The material obtained from the first reactor can therefore be the pre-treated graphite material or the metal sulfide-lean graphite material, depending on the operating conditions of the first reactor.

In some implementations, the first reactor can be optionally provided with an oxygen-containing gas inlet. In other implementations, the air contained in the first reactor and inherently present in the starting material to be oxidized is sufficient to allow the removal of the metal sulfide impurities. In some implementations, the oxidation step in the first reactor is performed at a temperature of 300° C. or lower, for example between 25° C. and 300° C. In such case, the oxidation step carried out in the first reactor is generally a partial oxidation step and the resulting pre-treated graphite material includes metal sulfates. The pre-treated graphite material is then further oxidized in the furnace, as the pre-treated graphite material is heated up for a carbochlorination step that will be described in further detail below. Alternatively, the first oxidation step in the first reactor can be performed at a temperature greater than 300° C. to enable complete oxidation of the metal sulfides and convert the metal sulfides into metal oxides and sulfur dioxide. In such case, the material introduced in the furnace can be directly subjected to the carbochlorination step.

Thus, when the first reactor is present, the pre-treated graphite material or the metal sulfide-lean graphite material produced by the first reactor is then introduced into the crucibles of the furnace described herein, with the packing material provided to fill the space between adjacent crucibles.

Once the starting material, the pre-treated graphite material or the metal sulfide-lean graphite material is placed into the crucible cavities of the crucibles of the furnace, an electrical current can then be generated between a first electrode and a second electrode of the furnace, the first and second electrodes being in electrical communication with an electrically conductive packing medium received within the furnace housing of the furnace and filling each of the gaps and to at least partially surrounding the crucibles. In some implementations, the first and second electrodes can be in direct contact with the outermost crucibles via their respective electrode end portions, while in other implementations, there can be a space, or gap, between the respective end portions of first and second electrodes and the outermost crucibles, such that the first and second electrodes are not in direct contact with the outermost crucibles.

The electric current can be maintained between the first electrode and the second electrode to reach a reaction temperature within the housing furnace and for a reaction time sufficient to produce the purified graphite product. In some implementations, the reaction temperature can range from about 300° C. to 3200° C., or from about 700° C. to about 1400° C. In some implementations, the reaction temperature can depend on the size of the crucibles. For instance, the dimensions of the crucibles can be chosen to be smaller to concentrate the resistive heating generated by the passage of the electrical current in a smaller volume, which can contribute to reach higher reaction temperatures, for instance reaction temperatures within the range of 2800° C. to 3200° C. The reaction time can vary for instance between 4 hours and 24 hours. In some implementations, the reaction time can depend on the amount of starting material, given that it can be desirable to limit the gas flow to reduce or prevent fluidisation.

As described herein, the predetermined width W of the gap between the adjacent ones of the crucibles can be chosen such that upon passage of an electrical current from the first electrode to the second electrode, resistive heating is generated through both the electrically conductive packing medium and the crucible sidewalls to heat the starting material.

In some implementations, subjecting the graphite material to oxidizing conditions can include injecting an oxygen-containing gas into the furnace; and heating the furnace to a first temperature that is lower than a decomposition temperature of the metal sulfide impurities. In some implementations, injecting the oxygen-containing gas includes injecting air. In some implementations, the oxygen-containing gas is air. The oxygen-containing gas can be injected into the furnace prior to heating the furnace to the first temperature. Alternatively, the oxygen-containing gas can be injected into the furnace as the furnace is heated to the first temperature. The first temperature can be selected to be lower than a decomposition temperature of the metal sulfide impurities. In some implementations, the first temperature is of up to about 300° C. In some embodiments, the first temperature is of less than about 700° C., to avoid decomposition of the graphite. In some implementations, injecting the oxygen-containing gas into the furnace is halted prior to subjecting the metal sulfide-lean graphite material to carbochlorination.

In some implementations, the process further includes injecting a first inert gas into the furnace to purge the sulfur dioxide from the furnace prior to subjecting the metal sulfide-lean graphite material to carbochlorination. The first inert gas can for example include at least one of argon and nitrogen.

The process can further include subjecting the metal sulfide-lean graphite material to carbochlorination, in the presence of chlorine gas, to convert the metal oxides into metal chlorides and produce a metal chloride-rich graphite material. Subjecting the metal sulfide-lean graphite material to carbochlorination can include heating the metal sulfide-lean graphite material to a temperature of at least about 1400° C., that is equal to or lower than about 3000° C. or than about 2500° C., of between about 1400° C. and about 2200° C.

In some implementations, a second inert gas can be introduced into the furnace to purge metal chlorides that are typically gaseous at the temperature at which is conducted the carbochlorination step, e.g., at temperatures between 700° C. and 2500° C. The furnace can then be maintained at a temperature at which the metal chlorides are in a gaseous state, and the off-gas, including the metal chlorides, can be recovered from the furnace.

In implementations where a second inert gas is introduced in the crucible cavities to remove metal chlorides, the reaction temperature within the furnace housing can be a temperature at which the metal chlorides are in a gaseous state, typically between 700° C. and 2500° C., as mentioned above.

In some implementations, the process can further include recovering off-gases generated during the production of the graphite product, which can include the metal chlorides as described above.

Following removal of the metal chlorides, a graphite product that is purified can then be obtained. The purified graphite product can optionally be further processed if desired. For example, the purified graphite product can optionally be coated (e.g., coated with pitch or other types of materials or other surface treatments) to obtain a coated purified graphite product.

Several alternative implementations and examples have been described and illustrated herein. The implementations of the technology described above are intended to be exemplary only. A person of ordinary skill in the art would appreciate the features of the individual implementations, and the possible combinations and variations of the components. A person of ordinary skill in the art would further appreciate that any of the implementations could be provided in any combination with the other implementations disclosed herein. It is understood that the technology may be embodied in other specific forms without departing from the central characteristics thereof. The present implementations and examples, therefore, are to be considered in all respects as illustrative and not restrictive, and the technology is not to be limited to the details given herein. Accordingly, while the specific implementations have been illustrated and described, numerous modifications come to mind.

1. A furnace for producing a graphite product, comprising:
a furnace housing comprising a furnace bottom wall and a furnace sidewall extending upwardly from the bottom wall;
an array of crucibles provided within the furnace housing, each of the crucibles having a crucible bottom wall and a crucible sidewall together defining a crucible cavity configured for receiving a starting material therein, the crucibles being distributed longitudinally spaced-apart from one another with adjacent ones of the crucibles being distanced from one another to define a gap having a predetermined width therebetween;
an electrically conductive packing medium received in the furnace housing to fill each of the gaps and to at least partially surround the crucibles; and
first and second electrodes each partially extending into the electrically conductive packing medium, the first and second electrodes being operatively connectable to a power source and being substantially aligned with the array of crucibles and in electrical communication therewith via the electrically conductive packing medium;
wherein the predetermined width of the gap between the adjacent ones of the crucibles is such that upon passage of an electrical current from the first electrode to the second electrode, resistive heating is generated through both the electrically conductive packing medium and the crucible sidewalls to heat the starting material.

2. The furnace of claim 1, wherein the predetermined width ranges from about 0.5 cm to about 30 cm.

3. The furnace of claim 1 or 2, wherein the predetermined width ranges from about 5 cm to about 25 cm.

4. The furnace of any one of claims 1 to 3, wherein the predetermined width ranges from about 10 cm to about 20 cm.

5. The furnace of any one of claims 1 to 4, wherein a ratio between a sidewall thickness of the crucibles and the predetermined width of the gap between the adjacent ones of the crucibles ranges from about 0.083 to about 20.

6. The furnace of any one of claims 1 to 5, wherein the electrically conductive packing medium comprises calcinated petroleum coke.

7. The furnace of claim 6, wherein the calcinated petroleum coke comprises particles having a size below 0.5 mm, between about 0.2 mm and about 2 mm, between about 5 mm and about 10 mm, or between about 10 mm and about 20 mm.

8. The furnace of any one of claims 1 to 7, wherein the electrically conductive packing medium has a bulk density ranging from about 500 kg/m³ to about 1200 kg/m³.

9. The furnace of any one of claims 1 to 8, wherein the electrically conductive packing medium entirely surrounds the crucibles.

10. The furnace of any one of claims 1 to 9, wherein the crucibles are rectangularly shaped.

11. The furnace of any one of claims 1 to 10, further comprising a gas inlet to introduce a gas in a corresponding one of the crucible cavities.

12. The furnace of claim 11, wherein the gas inlet comprises an injection lance to inject the gas in the corresponding one of the crucible cavities.

13. The furnace of claim 11 or 12, wherein the gas comprises an inert gas and/or a reactive gas.

14. The furnace of any one of claims 11 to 13, wherein the gas comprises chlorine, CFC, HFC, carbon monoxide, air, and/or oxygen.

15. The furnace of any one of claims 1 to 14, further comprising a dividing wall extending across a section of the crucible cavity to facilitate diffusion of heat.

16. The furnace of claim 15, wherein the dividing wall passes through a center region of the crucible cavity.

17. The furnace of claim 15 or 16, wherein the dividing wall extends substantially parallel to the first and second electrodes.

18. The furnace of claim 15 or 16, wherein the dividing wall extends substantially perpendicular to the first and second electrodes.

19. The furnace of claim 15 or 16, wherein the dividing wall comprises first and second dividing walls, the first dividing wall extending substantially parallel to the first and second electrodes and the second dividing wall extending substantially perpendicular to the first and second electrodes.

20. The furnace of claim 15 or 16, wherein the dividing wall comprises first and second dividing walls, the first and second dividing walls crossing each other to form a cross.

21. The furnace of claim 15 or 16, wherein the dividing wall is provided at a height that is substantially aligned with at least one of the first and second electrodes.

22. The furnace of claim 15 or 16, wherein the dividing wall extends upwardly from the crucible bottom up to a height of at least one of the first and second electrodes.

23. The furnace of claim 15 or 16, wherein the dividing wall extends upwardly from the crucible bottom up to a top region of the crucible cavity.

24. The furnace of any one of claims 1 to 23, wherein the starting material is selected from the group consisting of natural graphite, artificial graphite, exfoliated graphite, graphene materials, coke, and mixtures thereof.

25. The furnace of claim 24, wherein the starting material comprises recycled graphite.

26. The furnace of claim 24, wherein the coke comprises needle coke.

27. The furnace of any one of claims 1 to 25, wherein the starting material is a spheronized graphite material, and the graphite product is a spheronized and purified graphite product.

28. The furnace of any one of claims 1 to 25, wherein the starting material is a prismatic graphite material, and the purified graphite material is a prismatic and purified graphite material.

29. The furnace of any one of claims 1 to 28, wherein the furnace housing comprises first and second furnace housings within which is received a corresponding array of the crucibles, the first and second electrodes being in electrical communication with the corresponding arrays of the crucibles via a shunt.

30. The furnace of claim 29, wherein the first and second electrodes are provided on a same side of the first and second furnace housings.

31. The furnace of any one of claims 1 to 28, wherein the first and second electrodes are provided on opposite sides of the furnace housing.

32. The furnace of any one of claims 1 to 31, wherein the graphitization furnace further comprises a hood to recover off-gases generated during production of the graphite product.

33. The furnace of any one of claims 1 to 32, wherein the first electrode is in direct contact with a first outermost crucible on a first side of the array of crucibles, and the second electrode is in direct contact with a second outermost crucible on a second side of the array of crucibles.

34. The furnace of any one of claims 1 to 32, wherein the first and second electrodes each partially extends into the electrically conductive packing medium without directly contacting the crucibles.

35. A process for producing a graphite product, comprising:
placing a starting material into crucible cavities of corresponding crucibles forming part of an array of crucibles provided within a furnace housing of a furnace, the crucibles being distributed longitudinally spaced-apart from one another with adjacent ones of the crucibles being distanced from one another to define a gap having a predetermined width therebetween;
generating an electrical current between a first electrode and a second electrode of the furnace, the first and second electrodes being in electrical communication with an electrically conductive packing medium received within the furnace housing of the furnace to fill each of the gaps and to at least partially surround the crucibles;
maintaining the electrical current between the first electrode and the second electrode to reach a reaction temperature within the housing furnace and for a reaction time sufficient to produce the graphite product;
wherein the predetermined width of the gap between the adjacent ones of the crucibles is such that upon passage of an electrical current from the first electrode to the second electrode, resistive heating is generated through both the electrically conductive packing medium and the crucible sidewalls to heat the starting material.

36. The process of claim 35, wherein the reaction temperature ranges from about 300° C. to 3200° C.

37. The process of claim 35 or 36, wherein the reaction time ranges from about 4 hours and about 24 hours.

38. The process of any one of claims 35 to 37, further comprising recovering off-gases generated during the production of the graphite product.

39. The process of any one of claims 35 to 38, wherein the graphite product is a purified graphite product.

40. The process of claim 39, further comprising:
subjecting the starting material to oxidizing conditions, in presence of oxygen, to convert metal sulfide impurities into metal oxides and sulfur dioxide, thereby obtaining a metal sulfide-lean graphite material;
subjecting the metal sulfide-lean graphite material to carbochlorination, in presence of chlorine gas, to convert the metal oxides into metal chlorides and obtain a metal chloride-rich graphite material; and
purging the metal chlorides from the metal chloride-rich graphite material, thereby obtaining a purified graphite material.

41. The process of claim 40, wherein subjecting the starting material to oxidizing conditions comprises:
a first oxidation step performed at a first temperature that is lower than a decomposition temperature of the metal sulfide impurities, to convert the metal sulfide impurities into metal sulfates and obtain a pre-treated graphite material; and
a second oxidation step performed on the pre-treated graphite material at a second temperature that is higher than the first temperature, to convert the metal sulfates into metal oxides and sulfur dioxide and obtain the metal sulfide-lean graphite material.

42. The process of claim 41, wherein the first oxidation step is performed in a first reactor; and the second oxidation step, the subjecting the metal sulfide-lean graphite material to carbochlorination and the purging the metal chlorides are performed in the furnace.

43. The process of claim 42, wherein the first reactor is selected from the group consisting of kiln, a fluidized bed reactor, a fixed bed reactor and a rotating bed reactor.

44. The process of any one of claims 40 to 43, further comprising purging the sulfur dioxide from the metal sulfide-lean graphite material prior to subjecting the metal sulfide-lean graphite material to carbochlorination.

45. The process of claim 44, wherein purging the sulfur dioxide from the metal sulfide-lean graphite material comprises purging the sulfur dioxide with a first inert gas.

46. The process of any one of claims 40 to 45, wherein purging the metal chlorides from the metal chloride-rich graphite material comprises:
purging with a second inert gas;
maintaining the metal chloride-rich graphite material at a temperature at which the metal chlorides are in a gaseous state; and
recovering outlet gas comprising the metal chlorides.
